(19) United States
(12) Patent Application Publication
(10) Pub. No.: US 2023/0273382 A1
(43) Pub. Date: Aug. 31, 2023

(54) OPTICAL CABLE

(71) Applicant: SUMITOMO ELECTRIC INDUSTRIES, LTD., Osaka (JP)

(72) Inventors: Ryota FUKUMOTO, Osaka (JP); Nayu YANAGAWA, Osaka (JP); Taro FUJITA, Osaka (JP); Yohei SUZUKI, Osaka (JP); Fumiaki SATO, Osaka (JP)

(21) Appl. No.: 18/017,896

(22) PCT Filed: Aug. 5, 2021
(86) PCT No.: PCT/JP2021/029116

§ 371 Date: Jan. 25, 2023

(30) Foreign Application Priority Data
Aug. 6, 2020 (JP) 2020-134132

(51) Int. Cl. G02B 6/44

(52) U.S. Cl. CPC G02B 6/443

(57) ABSTRACT

An optical cable according to an embodiment of present disclosure includes following features. Asheath layer contains a liquid crystal polymer forming a liquid crystal phase and an olefin resin serving as a principal component, a content of the liquid crystal polymer is 2 mass% to 30 mass% relative to the sheath layer, a major axis of the liquid crystal phase is oriented in a longitudinal direction of the sheath layer, and in a region from a surface of the sheath layer to a depth of 5% of a thickness of the sheath layer, an average ratio of a length of the liquid crystal phase in a major axis direction to a length of the liquid crystal phase in a minor axis direction is 2.0 or more.

### TECHNICAL FIELD

The present disclosure relates to an optical cable. This application claims priority based on Japanese Patent Application No. 2020-134132 filed on Aug. 6, 2020, and the entire contents of the Japanese patent application are incorporated herein by reference.

### BACKGROUND ART

In recent years, with the spread of the Internet, FTTH (Fiber to The Home), which realizes high-speed communication services by introducing optical fibers into ordinary homes, has been rapidly expanding. A large number of optical fiber core wires are accommodated in an optical cable used for FTTH.

There is known an optical cable having a structure in which a plurality of tape core wires each including a plurality of optical fiber core wires are layered and collectively covered with a sheath material (see Japanese Unexamined Patent Application Publication No. 2003-295011).

### CITATION LIST

### Patent Literature

PTL 1: Japanese Unexamined Patent Application Publication No. 2003-295011

### SUMMARY OF INVENTION

An optical cable according to an embodiment of present disclosure includes a core wire portion and a sheath layer covering the core wire portion. The core wire portion is formed of one or more optical fiber core wires, the sheath layer covers at least a part of an outer periphery of an optical fiber core wire located at an outer periphery of the core wire portion, the sheath layer contains a liquid crystal polymer forming a liquid crystal phase and an olefin resin serving as a principal component, a content of the liquid crystal polymer is 2 mass% to 30 mass% relative to the sheath layer, a major axis of the liquid crystal phase is oriented in a longitudinal direction of the sheath layer, and in a region from a surface of the sheath layer to a depth of 5% of a thickness of the sheath layer, an average ratio of a length of the liquid crystal phase in a major axis direction to a length of the liquid crystal phase in a minor axis direction is 2.0 or more.

### BRIEF DESCRIPTION OF DRAWINGS

FIG. 1 is a schematic perspective view of an optical cable according to an embodiment of the present disclosure.

### DETAILED DESCRIPTION

### Problem to Be Solved by the Present Disclosure

The optical cable may be exposed to a low temperature of 0° C. or lower or a high temperature of room temperature or higher depending on the environment in which the optical cable is used. When such a heat cycle is repeated, the sheath layer expands and contracts in the longitudinal direction due to linear expansion, and the transmission loss of the optical cable may increase. Therefore, in the sheath layer of the optical cable, it is important to suppress the expansion and contraction of the sheath layer after the heat cycle.

The present disclosure has been made in view of the above circumstances, and an object of the present disclosure is to provide an optical cable capable of suppressing an increase in transmission loss due to expansion and contraction of a sheath layer after a heat cycle.

### Advantageous Effect of the Present Disclosure

The optical cable according to an embodiment of the present disclosure can suppress an increase in transmission loss due to expansion and contraction of the sheath layer after heat cycles.

### Description of Embodiments

First, embodiments of the present disclosure will be listed and explained.

(1) An optical cable according to an embodiment of present disclosure includes a core wire portion and a sheath layer covering the core wire portion. The core wire portion is formed of one or more optical fiber core wires, the sheath layer covers at least a part of an outer periphery of an optical fiber core wire located at an outer periphery of the core wire portion, the sheath layer contains a liquid crystal polymer forming a liquid crystal phase and an olefin resin serving as a principal component, a content of the liquid crystal polymer is 2 mass% to 30 mass% relative to the sheath layer, a major axis of the liquid crystal phase is oriented in a longitudinal direction of the sheath layer, and in a region from a surface of the sheath layer to a depth of 5% of a thickness of the sheath layer, an average ratio of a length of the liquid crystal phase in a major axis direction to a length of the liquid crystal phase in a minor axis direction is 2.0 or more.

As a result, an increase in transmission loss due to expansion and contraction of the sheath layer after heat cycle can be suppressed.

(2) The olefin resin may be a copolymer including a linkage unit derived from ethylene and a linkage unit derived from an α-olefin having a carbonyl group. This makes it possible to further suppress an increase in transmission loss due to expansion and contraction of the sheath layer after the heat cycle.

(3) The sheath layer may have a coefficient of linear expansion C1 and a modulus of elasticity E1, the coefficient of linear expansion C1 may be a coefficient of linear expansion of the sheath layer at -30° C. to 70° C., the modulus of elasticity E1 may be a modulus of elasticity of the sheath layer at -30° C., and a product of the coefficient of linear expansion C1 and the modulus of elasticity E1, C1 × E1, may be 0.25 MPa/K, or less. This makes it possible to further suppress an increase in transmission loss due to expansion and contraction of the sheath layer after the heat cycle.

(4) The content of the liquid crystal polymer may be 2 mass% to 10 mass% relative to the sheath layer. This makes it possible to further suppress an increase in transmission loss due to expansion and contraction of the sheath layer after the heat cycle.

### Details of Embodiments of Present Disclosure

A specific example of an optical cable according to an embodiment of the present disclosure (hereinafter also referred to as “embodiment of the present disclosure”) will be described below with reference to the drawings. In the drawings of the present disclosure, the same reference numerals represent the same or corresponding parts. In addition, dimensional relationships such as length, width, thickness, and depth are appropriately changed for clarification and simplification of the drawings, and do not necessarily represent actual dimensional relationships.

In the present specification, a notation in the form of “A to B” means a lower limit and an upper limit of a range (that is, from A to B), and when there is no description of a unit in A and a unit is described only in B, the unit of A and the unit of B are the same.

### Embodiment 1: Optical Cable

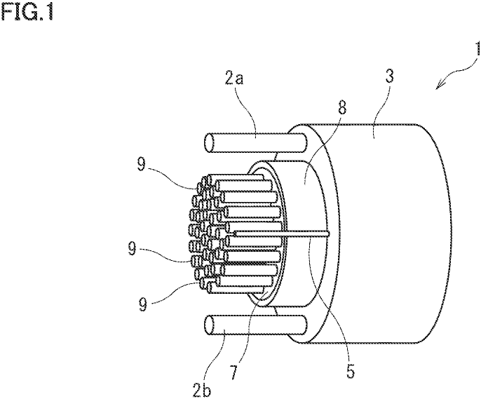

As shown in FIG. 1, an optical cable 1 according to an embodiment of the present disclosure includes a core wire portion and a sheath layer 3 covering the core wire portion. The core wire portion is formed of one or more optical fiber core wires 9, sheath layer 3 covers at least a part of an outer periphery of an optical fiber core wire 9 located at an outer periphery of the core wire portion, sheath layer 3 contains a liquid crystal polymer forming a liquid crystal phase and an olefin resin serving as a principal component, a content of the liquid crystal polymer is 2 mass% to 30 mass% relative to sheath layer 3, a major axis of the liquid crystal phase is oriented in a longitudinal direction of sheath layer 3, and in a region from a surface of the sheath layer to a depth of 5% of a thickness of the sheath layer, an average ratio of a length of the liquid crystal phase in a major axis direction to a length of the liquid crystal phase in a minor axis direction is 2.0 or more.

Thereby, it is possible to suppress an increase in transmission loss due to expansion and contraction of the sheath layer after the heat cycle. The reason is presumed to be as follows.

(a) In the above-mentioned optical cable 1, sheath layer 3 contains the liquid crystal polymer forming the liquid crystal phase and the olefin resin serving as a principal component, the content of the liquid crystal polymer is 2 mass% to 30 mass% relative to sheath layer 3, and the major axis of the liquid crystal phase is oriented in the longitudinal direction of sheath layer 3. As a result, the coefficient of linear expansion of sheath layer 3 can be reduced, and the effect of suppressing the expansion and contraction of sheath layer 3 in the longitudinal direction can be improved. Here, “the major axis of the liquid crystal phase is oriented in the longitudinal direction of the sheath layer” means that the shape of the liquid crystal phase phase-separated from the olefin resin serving as the principal component is extended in the longitudinal direction of the sheath layer.

(b) In addition, when the average ratio of the length of the liquid crystal phase in the major axis direction to the length of the liquid crystal phase in the minor axis direction is 2.0 or more in the region from the surface of the sheath layer to the depth of 5% of the thickness of the sheath layer, the effect of suppressing an increase in transmission loss due to expansion and contraction of the sheath layer after the heat cycle can be improved.

As described above, the above-mentioned optical cable can suppress an increase in transmission loss due to expansion and contraction of the sheath layer after a heat cycle.

### Optical Cable

The optical cable includes a core wire portion and a sheath layer covering the core wire portion. The core wire portion is formed of one or more optical fiber core wires. Also, the sheath layer covers at least a part of an outer periphery of an optical fiber core wire located at an outer periphery of the core wire portion. The optical cable accommodates an optical fiber core wire that transmits a signal using physical properties of light. FIG. 1 is a schematic perspective view of an optical cable according to an embodiment of the present disclosure. Optical cable 1 shown in FIG. 1 includes a core wire portion formed of a plurality of optical fiber core wires 9 and a sheath layer 3 covering the core wire portion. In FIG. 1, a tape member 8 such as a nonwoven fabric is wound around the plurality of optical fiber core wires 9 as a press-winding member between sheath layer 3 and optical fiber core wires 9. The number of optical fiber core wires 9 may be one. In FIG. 1, a space 7 is formed between tape member 8 and optical fiber core wire 9. Further, in FIG. 1, sheath layer 3 is provided with tension members 2a and 2b and a sheath layer peeling cord 5. Here, “the sheath layer covers at least a part of the outer periphery of the optical fiber core wire located at the outer periphery of the core wire portion” means that the sheath layer and the optical fiber core wire located at the outer periphery of the core wire portion are not necessarily in contact with each other, and for example, a tape member may be interposed therebetween.

### Optical Fiber Core Wire

Optical fiber core wire 9 is a thin fiber-like substance formed of quartz glass or plastic, and has a two layer structure of a core at a central portion (not shown) and a cladding surrounding the core. The core is designed to have a higher refractive index than the cladding, and light propagates in a state of being confined in the core due to a phenomenon called total reflection.

### Tension Member

Tension members 2a and 2b protect the optical fiber from tension applied during installation. As tension members 2a and 2b, a steel wire or an aramid fiber reinforced plastic is mainly used.

### Sheath Layer

Sheath layer 3 serves to protect the optical fiber from various installation environments, and is layered on the outer sides of optical fiber core wires 9 around which tape member 8 is wound. Sheath layer 3 includes a liquid crystal polymer forming a liquid crystal phase and an olefin resin serving as a principal component. Here, the “principal component” refers to a component having the highest content among the constituent components, and preferably refers to a component having a content of 50 mass% or more. In addition, the sheath layer may further contain other components. Here, examples of the “other components” include a compatibilizer described below, other additives, and other resins other than the olefin resin.

### Olefin Resin

Examples of the olefin resin include a high density polyethylene (HDPE), a low density polyethylene (LDPE), a linear low density polyethylene (LLDPE), and a copolymer containing a linkage unit derived from ethylene and a linkage unit derived from α-olefin having a carbonyl group. Among them, the olefin resin is preferably a copolymer containing a linkage unit derived from ethylene and a linkage unit derived from an α-olefin having a carbonyl group. Thereby, the compatibility with the liquid crystal polymer is improved and the tensile elongation can be improved. The sheath layer may contain two or more kinds of olefin resins.

Examples of the α-olefin having a carbonyl group include (meth)acrylic acid alkyl esters such as methyl (meth)acrylate and ethyl (meth)acrylate; (meth)acrylic acid aryl esters such as phenyl (meth)acrylate; vinyl esters such as vinyl acetate and vinyl propionate; unsaturated acids such as (meth)acrylic acid, crotonic acid, maleic acid and itaconic acid; vinyl ketones such as methyl vinyl ketone and phenyl vinyl ketone; and (meth)acrylic acid amides. Among these, (meth)acrylic acid alkyl esters and vinyl esters are preferable, and ethyl acrylate and vinyl acetate are more preferable.

Examples of the copolymer containing a linkage unit derived from ethylene and a linkage unit derived from an α-olefin having a carbonyl group include resins such as ethylene-vinyl acetate copolymer (EVA), ethylene-ethyl acrylate copolymer (EEA), ethylene-methyl acrylate copolymer (EMA), and ethylene-butyl acrylate copolymer (EBA). Among them, EVA and EEA are preferable.

The lower limit of the content of the olefin resin is preferably 50 mass% or more, and more preferably 70 mass% or more relative to sheath layer 3. On the other hand, the upper limit of the content of the olefin resin is preferably 98 mass% or less, and more preferably 95 mass% or less relative to sheath layer 3. When the content of the olefin resin is less than the lower limit, the effect of improving bending resistance at low temperatures and in a temperature range of room temperature or higher may be insufficient.

### Liquid Crystal Polymer

The liquid crystal polymer is an aromatic polyester that forms a liquid crystal phase. In addition, the major axis of the liquid crystal phase is oriented in the longitudinal direction of the sheath layer. In the optical cable, “the major axis of the liquid crystal phase is oriented in the longitudinal direction of the sheath layer” can be obtained by the following method. First, an arbitrary position of the optical cable is cut in the thickness direction of the sheath layer along the longitudinal direction of the sheath layer to prepare a sample including a cross section of the sheath layer. Then, any 30 liquid crystal phases in the cross section are observed using a transmission electron microscope (TEM). Thus, it can be confirmed that in the optical cable, “the major axis of the liquid crystal phase is oriented in the longitudinal direction of the sheath layer” by confirming that the shape of the liquid crystal phase phase-separated from the olefin resin which is the principal component is extended in the longitudinal direction of the sheath layer for all of the 30 liquid crystal phases.

The content of the liquid crystal polymer is 2 mass% to 30 mass% relative to the sheath layer. The content of the liquid crystal polymer is preferably 2 mass% to 10 mass% relative to the sheath layer. As a result, the effect of reducing the coefficient of linear expansion of the above-mentioned optical cable is further improved, and the effect of suppressing the expansion and contraction of the sheath layer after heat cycles can be further enhanced.

The lower limit of the content of the liquid crystal polymer is preferably 3 mass% or more, more preferably 5 mass% or more, and still more preferably 7 mass% or more relative to sheath layer 3. On the other hand, the upper limit of the content of the liquid crystal polymer is preferably 28 mass% or less, more preferably 20 mass% or less, and still more preferably 15 mass% or less relative to sheath layer 3. The content of the liquid crystal polymer is preferably 3 mass% to 28 mass%, more preferably 5 mass% to 20 mass%, and still more preferably 7 mass% to 15 mass% relative to sheath layer 3. When the content of the liquid crystal polymer is less than 2 mass% relative to sheath layer 3, the effect of reducing the coefficient of linear expansion is reduced, and the expansion and contraction of the sheath layer after heat cycles may not be sufficiently suppressed. On the other hand, when the content of the liquid crystal polymer is more than 30 mass% relative to sheath layer 3, the surface properties and bending resistance of sheath layer 3 after extrusion may be deteriorated.

In a region from a surface of the sheath layer to a depth of 5% of a thickness of the sheath layer, an average ratio of a length of the liquid crystal phase in a major axis direction to a length of the liquid crystal phase in a minor axis direction is 2.0 or more. Accordingly, the effect of suppressing the expansion and contraction of the sheath layer in the longitudinal direction is improved. The lower limit of the average ratio is preferably 2.5 or more, more preferably 3.5 or more, and still more preferably 5.0 or more. Here, the “length of the liquid crystal phase in a minor axis direction” refers to the length in the direction perpendicular to the major axis direction at the center of the major axis (axis in the longitudinal direction) of the liquid crystal phase.

In the optical cable, the “average ratio of a length of the liquid crystal phase in a major axis direction to a length of the liquid crystal phase in a minor axis direction” can be obtained by the following method. First, an arbitrary position of the optical cable is cut in the thickness direction of the sheath layer along the longitudinal direction of the sheath layer to prepare a sample including a cross section of the sheath layer. Next, by observing the cross section using a transmission electron microscope (TEM), the length of the liquid crystal phase in the major axis direction and the length of the liquid crystal phase in the minor axis direction are measured for any one liquid crystal phase on the TEM image. Next, the “ratio of a length of the liquid crystal phase in a major axis direction to a length of the liquid crystal phase in a minor axis direction” is obtained by dividing the length of the liquid crystal phase in the major axis direction by the length of the liquid crystal phase in the minor axis direction. In the cross section, the “ratio of a length of the liquid crystal phase in a major axis direction to a length of the liquid crystal phase in a minor axis direction” of a total of 30 liquid crystal phases are obtained. Next, by calculating the average value of the “ratio of a length of the liquid crystal phase in a major axis direction to a length of the liquid crystal phase in a minor axis direction”, the “average ratio of a length of the liquid crystal phase in a major axis direction to a length of the liquid crystal phase in a minor axis direction” can be obtained.

### Compatibilizer

Sheath layer 3 may further contain a compatibilizer. When sheath layer 3 contains the compatibilizer, the interfacial tension between the olefin resin, which is the principal component of the sheath layer, and the liquid crystal polymer is reduced, and the compatibility between the olefin resin and the liquid crystal polymer can be further improved. Here, the acid-modified olefin resin may be an olefin resin having an acidic functional group in a side chain, an olefin resin having an acidic functional group incorporated into a main chain, or an olefin resin having an acidic functional group in a side chain and an acidic functional group incorporated into a main chain.

The compatibilizer is preferably an acid-modified polyolefin. Examples of the polyolefin resin to be subjected to acid modification include polyethylene and polypropylene. Among them, polyethylene is preferable. Examples of the polyethylene include very low-density polyethylene (VLDPE) and linear low-density polyethylene (LLDPE). Among them, very low-density polyethylene is preferable from the viewpoint of flexibility of the resin.

The acid used for acid modification is not particularly limited as long as it does not impair the effects of the present disclosure, and examples thereof include unsaturated carboxylic acids and derivatives thereof. Examples of the unsaturated carboxylic acid include acrylic acid, methacrylic acid, maleic acid, itaconic acid, fumaric acid and the like. Examples of the derivative of the unsaturated carboxylic acid include maleic acid monoester, maleic anhydride, itaconic acid monoester, itaconic anhydride, fumaric acid monoester, and fumaric anhydride. Among these, from the viewpoint of further improving the adhesion (compatibility) between the olefin resin and the liquid crystal polymer, a derivative of an unsaturated carboxylic acid is preferable, and maleic anhydride is more preferable.

As the acid-modified polyolefin, maleic anhydride-modified ultra-low density polyethylene and maleic anhydride-modified linear low-density polyethylene are preferable. Among them, maleic anhydride-modified ultra-low density polyethylene is more preferable from the viewpoint of flexibility of the resin.

The lower limit of the content of the compatibilizer is preferably 2 mass% or more relative to sheath layer 3. On the other hand, the upper limit of the content of the compatibilizer is preferably 30 mass% or less. When the content of the compatibilizer is less than the lower limit, compatibility may not be sufficiently imparted. On the other hand, when the content of the compatibilizer exceeds the upper limit, the extrusion appearance may be deteriorated.

Sheath layer 3 may contain other additives such as a flame retardant, a flame retardant aid, an antioxidant, a lubricant, a colorant, a reflection imparting agent, a masking agent, a processing stabilizer, and a plasticizer. In addition, sheath layer 3 may contain a resin other than the olefin resin.

Preferably, the sheath layer has a coefficient of linear expansion C1 and a modulus of elasticity E1, coefficient of linear expansion C1 is a coefficient of linear expansion of the sheath layer at -30° C. to 70° C., modulus of elasticity E1 is a modulus of elasticity of the sheath layer at -30° C., and a product of coefficient of linear expansion C1 and modulus of elasticity E1, C1 × E1, is 0.25 MPa/K or less. As a result, the effect of suppressing an increase in transmission loss due to expansion and contraction of the sheath layer after the heat cycle can be improved. As a mechanism thereof, when at least one of the modulus of elasticity at a low temperature and in a temperature range of room temperature or higher and the coefficient of linear expansion is relatively small, the stress of the sheath layer trying to contract at a low temperature is suppressed, and an increase in transmission loss accompanying the contraction can be suppressed. The upper limit of C1 × E1 is more preferably 0.15 MPa/K or more. The above-mentioned C1 × E1 can be adjusted by the kind, content ratio and the like of the olefin resin.

The term “coefficient of linear expansion” as used herein refers to a linear expansion coefficient measured in accordance with the test method for dynamic mechanical properties described in JIS-K7244-4 (1999), and is a value calculated from a dimensional change of a thin sheet with respect to a change in temperature using a viscoelasticity measuring device (for example, “DVA-220” manufactured by IT Keisoku Control Co., Ltd.) under conditions of a tensile mode, a temperature range of -60° C. to 80° C., a temperature rising rate of 5° C./min, a frequency 10 Hz, and a strain of 0.05%. Therefore, coefficient of linear expansion C1 is measured in accordance with the test method for dynamic mechanical properties described in JIS-K7244-4 (1999). To be specific, coefficient of linear expansion C1 is calculated from a dimensional change of a thin sheet with respect to a temperature change using a viscoelasticity measuring device (“DVA-220” manufactured by IT Keisoku Control Co., Ltd.) under conditions of a tensile mode, a temperature range of -60° C. to 80° C., a temperature rising rate of 5° C./min, a frequency 10 Hz, and a strain of 0.05%.

Here, the “modulus of elasticity” is a value measured in accordance with the test method for dynamic mechanical properties described in JIS-K7244-4 (1999), and is a value of storage modulus of elasticity measured using a viscoelasticity measuring device (for example, “DVA-220” manufactured by IT Keisoku Control Co., Ltd.) under conditions of a tensile mode, a temperature range of -60° C. to 80° C., a temperature rising rate of 5° C./min, a frequency 10 Hz, and a strain of 0.05%. Therefore, modulus of elasticity E1 is measured in accordance with the test method for dynamic mechanical properties described in JIS-K7244-4 (1999). To be specific, modulus of elasticity E1 is measured using a viscoelasticity measuring device (“DVA-220” manufactured by IT Keisoku Control Co., Ltd.) under conditions of a tensile mode, a temperature range of -60° C. to 80° C., a temperature rising rate of 5° C./min, a frequency of 10 Hz, and a strain of 0.05%.

C1 × E1 is obtained by calculating the product of C1 and E1.

The upper limit of coefficient of linear expansion C1 is preferably 150 (10⁻⁸/K) or less, more preferably 100 (10⁻³/K) or less, and still more preferably 70 (10⁻⁸/K) or less.

The lower limit of modulus of elasticity E1 is preferably 200 MPa or more, more preferably 300 MPa or more, and still more preferably 400 MPa or more. On the other hand, the upper limit of modulus of elasticity E1 is preferably 3000 MPa or less, more preferably 2000 MPa or less, and still more preferably 1500 MPa or less. Modulus of elasticity E1 is preferably from 200 MPa to 3000 MPa, more preferably from 300 MPa to 2000 MPa, and still more preferably from 400 MPa to 1500 MPa. When modulus of elasticity E1 is smaller than 200 MPa, the lateral pressure resistance at low temperatures may be insufficient. On the other hand, if modulus of elasticity E1 exceeds 3000 MPa, the flexibility at low temperatures may decrease and routing may become difficult.

The upper limit of C1 × E1 is preferably 0.25 or less, more preferably 0.20 or less, and still more preferably 0.15 or less.

Preferably, the sheath layer has a modulus of elasticity E2, modulus of elasticity E2 is a modulus of elasticity of the sheath layer at 25° C., and the lower limit of modulus of elasticity E2 is 200 MPa or more. Thereby, the lateral pressure resistance at room temperature can be enhanced. The lower limit of modulus of elasticity E2 is more preferably 300 MPa or more, and still more preferably 400 MPa or more. On the other hand, the upper limit of modulus of elasticity E2 is preferably 3000 MPa or less, more preferably 2000 MPa or less, and still more preferably 1000 MPa or less. Modulus of elasticity E2 is preferably 200 MPa to 3000 MPa, more preferably 300 MPa to 2000 MPa, and still more preferably 400 MPa to 1000 MPa. W hen modulus of elasticity E2 is smaller than 200 MPa, the lateral pressure resistance at room temperature may be insufficient. On the other hand, when modulus of elasticity E2 exceeds 3000 MPa, the flexibility at room temperature decreases, and there is a possibility that routing becomes difficult. Modulus of elasticity E2 is measured in accordance with the test method for dynamic mechanical properties described in JIS-K7244-4 (1999). To be specific, modulus of elasticity E2 is measured using a viscoelasticity measuring device (“DVA-220” manufactured by IT Keisoku Control Co., Ltd.) under conditions of a tensile mode, a temperature range of -60° C. to 80° C., a temperature rising rate of 5° C./min, a frequency 10 Hz, and a strain of 0.05%.

Sheath layer 3 preferably has a tensile elongation of 100% or more. When the tensile elongation is 100% or more, cracking at the time of bending and breakage under the use environment can be suppressed. The tensile elongation of sheath layer 3 is obtained by measurement based on 4.16 of JIS-C3005:2014. The above-mentioned measurement is performed in an environment at a room temperature of 25° C.

The average thickness of sheath layer 3 is not particularly limited, but is preferably, for example, 0.5 mm to 3.0 mm. Here, the “average thickness” refers to an average value of thicknesses measured at arbitrary ten points. In the following description, the term “average thickness” of other members is defined in the same manner.

In the optical cable, the sheath layer may have a multilayer structure. In the optical cable, the sheath layer may be a single layer or may have a multilayer structure of three or more layers.

### Embodiment 2: Method for Manufacturing Optical Cable

The optical cable according to the embodiment of the present disclosure can be obtained by a manufacturing method mainly including a step (first step) of preparing the core wire portion and a step (second step) of forming the sheath layer covering the core wire portion.

### First Step: Step of Preparing Core Wire Portion

The first step is to prepare the core wire portion. In other words, the core wire portion formed of one or more optical fiber core wires is prepared. The above-mentioned core wire portion may be a commercially available product or may be manufactured by a general method.

### Second Step: Step of Forming Sheath Layer Covering the Core Wire Portion

The second step is to form the sheath layer covering the core wire portion. Examples of the step include a step of extruding a sheath layer-forming composition, which contains a liquid crystal polymer and an olefin resin as a principal component and which causes the content of the liquid crystal polymer in the sheath layer to be 2 mass% to 30 mass%, to the outer peripheries of the optical fiber core wires. In the above-mentioned step, for example, the temperature of the extruder for the sheath layer may be 200° C. to 260° C. In the above-mentioned step, for example, the extrusion linear velocity may be 5 m/min or more.

According to the manufacturing method including these steps, the coefficient of linear expansion of the sheath layer can be reduced. Therefore, the above-mentioned optical cable can suppress an increase in transmission loss due to expansion and contraction of the sheath layer after a heat cycle.

### EXAMPLES

Next, the present invention will be described in more detail based on examples. However, the examples do not limit the scope of the present invention.

### Sheath Layer No. 1 to No. 13 for Optical Cable

In order to manufacture optical cables including sheath layers of No. 1 to No. 13, a core wire portion (product name: PureAccess-PB, manufactured by Sumitomo Electric Industries, Ltd.) including 432 optical fiber core wires was prepared (first step). Next, a sheath layer-forming composition was prepared according to the formulation shown in Table 1, and the sheath layer-forming composition was extruded to the outer periphery of the core wire portion to form tubular sheath layers No. 1 to No. 13 having average outer diameters of 10.0 mm and average thicknesses of 1.5 mm (second step). The composition of the sheath layer-forming composition is shown in Table 1. “-” indicates that the corresponding component is not used.

### Olefin Resin

In Table 1, the olefin resins used are as follows. Hereinafter, EA represents ethyl acrylate and VA represents vinyl acetate.
(1) EEA (EA: 18%) (ethylene-ethyl acrylate copolymer)
   “NUC6170s” manufactured by NUC Co., Ltd.
   Content of EA unit 18%) mass%, density 0.93 g/cm³
(2) EVA (VA: 35%) (ethylene-vinyl acetate copolymer)
   “Evaflex EV360” manufactured by Mitsui Dow Polychemicals Co., Ltd.
   Content of VA unit 35 mass%, density 0.95 g/cm³
(3) HDPE (high-density polyethylene)
   “DGDA6320” manufactured by DOW, density 0.96 g/cm³
(4) LLDPE (linear low density polyethylene).
   “NUCG9121” manufactured by NUC Co., Ltd.,) density 0.93 g/cm³
(5) VLDPE (very low density polyethylene).
   “TAFMER DF110” manufactured by Mitsui Chemicals, Inc., density 0.91 g/cm³
(6) Acid-modified VLDPE (acid-modified very-low-density polyethylene)
   “TAFMER MH5020” manufactured by Mitsui Chemicals, Inc. density 0.87 g/cm³
   Maleic anhydride modified very low density polyethylene (maleic anhydride modified VLDPE)

### Liquid Crystal Polymer

“LCPA8100” manufactured by Ueno Pharmaceutical Co., Ltd. was used as a low-melting point liquid crystal polymer having a melting temperature of 220° C.

### Evaluation

With respect to the sheath layers for optical cables of No. 1 to No. 13, surface properties of the sheath layer after extrusion, modulus of elasticity E1, coefficient of linear expansion C1, modulus of elasticity E2, product of coefficient of linear expansion C1 at -30° C. to 70° C. and modulus of elasticity E1 at -30° C. (C1 × E1), 90° bending test, 180° bending test, tensile properties, average ratio of a length of the liquid crystal phase in a major axis direction to a length of the liquid crystal phase in a minor axis direction, and orientation of major axis of liquid crystal phase in the sheath layer were evaluated.

### Surface Properties of Sheath Layer After Extrusion

The surface property of the sheath layer was evaluated in three stages of A to C. The evaluation criteria for the change in the shape of the sheath layer were as follows. The arithmetic average roughness Ra of the outer surface was measured over the length of 15 mm of the outer surface of the sheath using a stylus type surface roughness meter in accordance with JIS-B0601 (2013).
A: Best: Ra less than 2.0
B: Good: Ra 2.0 to 8.0
C: Poor: Ra more than 8.0

### Coefficient of Linear Expansion and Modulus of Elasticity

With respect to the sheath layers for optical cables No. 1 to No. 13, modulus of elasticity E1 and modulus of elasticity E2 were determined by the method described in the first embodiment. The results are shown in Table 1.

In addition, with respect to the sheath layers for optical cables No. 1 to No. 13, coefficient of linear expansion C1 was determined by the method described in Embodiment 1. With respect to the sheath layers of the optical cables No. 1 to No. 13, C1 × E1 was calculated by the method described in Embodiment 1.

### 90° Bending Test

The horizontally disposed sheath layers No. 1 to No. 13 were bent at 90°, and then a change in shape was observed. Based on the change in the state of the sheath layer after 90° bending, the evaluation was made in three stages of A to C. The evaluation criteria for the change in the shape of the sheath layer were as follows.
A: There is no problem in shape change.
B: Cracking is observed.
C: Breakage was observed.

### 180° Bending Test

The horizontally disposed sheath layers No. 1 to No. 13 were bent at 180°, and then a change in shape was observed. Based on the change in the state of the sheath layer after 180° bending, the evaluation was made in three stages of A to C. The evaluation criteria for the change in the shape of the sheath layer were as follows.
A: There is no problem in shape change.
B: Cracking is observed.
C: Breakage was observed.

### Tensile Strength and Tensile Elongation

With respect to the sheath layers for optical cables No. 1 to No. 13, tensile strength and tensile elongation were measured based on 4.16 of JIS-C3005:2014.

### Average Ratio of Length of Liquid Crystal Phase in Major Axis Direction to Length of Liquid Crystal Phase in Minor Axis Direction

With respect to the sheath layers for optical cables No. 1 to No. 13, in a region from a surface of the sheath layer to a depth of 5% of the thickness of the sheath layer, the average ratio of the length of the liquid crystal phase in the major axis direction to the length of the liquid crystal phase in the minor axis direction were determined by the method described in Embodiment 1.

### Orientation of Major Axis of Liquid Crystal Phase in Sheath Layer

For the optical cables including the sheath layers of No. 1 to No. 13, the orientation of the major axis of the liquid crystal phase in the sheath layer was confirmed by the method described in Embodiment 1. As a result, it was confirmed that in the optical cables including the sheath layers of No. 1 to No. 11 and No. 13, the major axis of the liquid crystal phase was oriented in the longitudinal direction of the sheath layer.

The evaluation results are shown in Table 1.

TABLE 1

| | | | No.1 | No.2 | No.3 | No.4 | No.5 | No.6 | No.7 | No.8 | No.9 | No.10 | No.11 | No.12 | No.13 |
|---|---|---|---|---|---|---|---|---|---|---|---|---|---|---|---|
| Sheath Layer | Content of Polyolefin-Based Resin (Mass%) | EEA(EA:18%) | 98 | 95 | 90 | 80 | 70 | 80 | 70 | - | - | - | - | 100 | 60 |
| | | EVA(VA:35%) | - | - | - | - | - | - | - | 90 | - | - | - | - | - |
| | | HDPE | - | - | - | - | - | - | - | - | 90 | - | - | - | - |
| | | LLDPE | - | - | - | - | - | - | - | - | - | 90 | - | - | - |
| | | VLDPE | - | - | - | - | - | - | - | - | - | - | 90 | - | - |
| | Compatibilizer (Mass%) | Acid-Modified VLDPE | - | - | - | 10 | 20 | - | - | - | - | - | - | - | - |
| | Liquid Crystal Polymer (Mass%) | Low-Melting Point Liquid Crystal Polymer | 2 | 5 | 10 | 10 | 10 | 20 | 30 | 10 | 10 | 10 | 10 | - | 40 |
| Evaluation | Surface Properties of Sheath Layer after Extrusion | | A | A | A | A | A | A | A | A | B | B | B | A | C |
| | Modulus of Elasticity [MPa] | -30° C.:E1 | 1205 | 1284 | 1588 | 1225 | 1309 | 1998 | 2687 | 1320 | 2510 | 2314 | 1741 | 980 | 3453 |
| | | 25° C.:E2 | 390 | 445 | 578 | 466 | 529 | 621 | 732 | 453 | 1527 | 1527 | 766 | 65 | 891 |
| | Coefficient of Linear Expansion (-30° C. to 70° C.):C1 [10⁻⁶/K] | | 125 | 97 | 88 | 87 | 98 | 74 | 73 | 98 | 78 | 49 | 89 | 272 | 75 |
| | Product of Coefficient of Linear Expansion and Modulus of Elasticity (-30° C.), C1×E1[MPa/K] | | 0.15 | 0.12 | 0.14 | 0.11 | 0.13 | 0.15 | 0.20 | 0.13 | 0.20 | 0.11 | 0.15 | 0.27 | 0.26 |
| | 90°C Bending Test State after Bending | | A | A | A | A | A | A | A | A | A | A | A | A | C |
| | 180° C. Bending Test State after Bending | | A | A | B | A | A | B | B | B | B | B | B | A | C |
| | Tensile Properties | Tensile Strength (MPa) | 6.8 | 7.0 | 9.9 | 8.8 | 9.7 | 10.9 | 12.5 | 8.9 | 26.5 | 18.9 | 8.7 | 7.5 | 12.5 |
| | | Tensile Elongation (%) | 710 | 640 | 130 | 190 | 200 | 120 | 100 | 120 | 20 | 60 | 70 | 810 | 10 |
| | Orientation of Major Axis of Liquid Crystal Phase in Sheath Layer | | Longitudinal Direction | Longitudinal Direction | Longitudinal Direction | Longitudinal Direction | Longitudinal Direction | Longitudinal Direction | Longitudinal Direction | Longitudinal Direction | Longitudinal Direction | Longitudinal Direction | Longitudinal Direction | - | Longitudinal Direction |
| | Average Ratio of Length of Liquid Crystal Phase in Major Axis Direction to Length of Liquid Crystal Phase in Minor Axis Direction | | 5.2 | 4.8 | 4.3 | 3.6 | 2.3 | 3.9 | 3.5 | 3.6 | 4.3 | 4.1 | 4.4 | - | 3.0 |

As shown in Table 1, in the optical cables including the sheath layers of No. 1 to No. 11, each of the sheath layers contains the liquid crystal polymer and the olefin resin, the content of the liquid crystal polymer is 2 mass% to 30 mass% relative to the sheath layer, and in the region from the surface of the sheath layer to the depth of 5% of the thickness of the sheath layer, the average ratio of the length of the liquid crystal phase in the major axis direction to the length of the liquid crystal phase in the minor axis direction is 2.0 or more. The optical cables including the sheath layers of No. 1 to No. 11 had a reduced coefficient of linear expansion of the sheath layer, a preferred effect of suppressing the expansion and contraction in the longitudinal direction of the sheath layer shown in the bending test, and preferred value of the product C1 × E1 of coefficient of linear expansion C1 from -30° C. to 70° C. and modulus of elasticity E1 at -30° C. In addition, each of the optical cables including the sheath layers of No. 1 to No. 8 in which the olefin resin was a copolymer including a linkage unit derived from ethylene and a linkage unit derived from an α-olefin having a carbonyl group had good surface properties and tensile elongation.

On the other hand, in the optical cable including the sheath layer of No. 12 which does not contain the liquid crystal polymer and in which, in the region from the surface of the sheath layer to the depth of 5% of the thickness of the sheath layer, the average ratio of the length of the liquid crystal phase in the major axis direction to the length of the liquid crystal phase in the minor axis direction is not 2.0 or more, and in the optical cable including the sheath layer of No. 13 in which the content of the liquid crystal polymer exceeds 30 mass% relative to the sheath layer, C1 × E1 is high and it is considered that the effect of suppressing the increase in transmission loss due to the expansion and contraction of the sheath layer after the heat cycle is poor. Further, the optical cable having the sheath layer of No. 13 was very poor in surface properties, bending resistance and tensile elongation.

From the above, it can be seen that in the above-mentioned optical cable, the coefficient of linear expansion of the sheath layer is reduced, and an increase in transmission loss due to expansion and contraction of the sheath layer after heat cycles can be suppressed.

Although the embodiments and examples of the present disclosure have been described above, it is originally intended that the configurations of the above-described embodiments and examples be appropriately combined or variously modified.

It should be understood that the embodiments and examples disclosed herein are illustrative in all respects and are not restrictive. The scope of the present invention is defined not by the above-described embodiments and examples but by the claims, and is intended to include meanings equivalent to the claims and all modifications within the scope.

### REFERENCE SIGNS LIST

1 optical cable, 2a, 2b tension member, 3 sheath layer, 5 sheath layer peeling cord, 7 space, 8 tape member, 9 optical fiber core wire

1. An optical cable comprising a core wire portion and a sheath layer covering the core wire portion,
wherein the core wire portion is formed of one or more optical fiber core wires,
the sheath layer covers at least a part of an outer periphery of an optical fiber core wire located at an outer periphery of the core wire portion,
the sheath layer contains a liquid crystal polymer forming a liquid crystal phase and an olefin resin serving as a principal component,
a content of the liquid crystal polymer is 2 mass% to 30 mass% relative to the sheath layer,
a major axis of the liquid crystal phase is oriented in a longitudinal direction of the sheath layer, and
in a region from a surface of the sheath layer to a depth of 5% of a thickness of the sheath layer, an average ratio of a length of the liquid crystal phase in a major axis direction to a length of the liquid crystal phase in a minor axis direction is 2.0 or more.

2. The optical cable according to claim 1, wherein the olefin resin is a copolymer including a linkage unit derived from ethylene and a linkage unit derived from an α-olefin having a carbonyl group.

3. The optical cable according to claim 1,
wherein the sheath layer has a coefficient of linear expansion C1 and a modulus of elasticity E1,
the coefficient of linear expansion C1 is a coefficient of linear expansion of the sheath layer at -30° C. to 70° C.,
the modulus of elasticity E1 is a modulus of elasticity of the sheath layer at -30° C., and
a product of the coefficient of linear expansion C1 and the modulus of elasticity E1, C1 × E1, is 0.25 MPa/K or less.

4. The optical cable according to claim 1, wherein the content of the liquid crystal polymer is 2 mass% to 10 mass% relative to the sheath layer.
